(19) United States
(12) Patent Application Publication
(10) Pub. No.: US 2024/0375748 A1
(43) Pub. Date: Nov. 14, 2024

(54) BOTTOM BRACKET BEARING AND VEHICLE

(71) Applicant: DELTA FORCE SOLUTIONS GMBH, Borken (DE)

(72) Inventor: David Hune, Borken (DE)

(21) Appl. No.: 18/688,262

(22) PCT Filed: Aug. 30, 2022
(86) PCT No.: PCT/EP2022/074004

§ 371 Date: Feb. 29, 2024

(30) Foreign Application Priority Data
Aug. 31, 2021 (DE) 10 2021 122 525.6

(51) Int. Cl. B62M 6/50

(52) U.S. Cl. CPC B62M 6/50

(57) ABSTRACT

Bottom bracket bearing (40), with a bottom bracket bearing shaft (42), a torsion element (44) connected on the driving side to the bottom bracket bearing shaft (42) for conjoint rotation and having a torsion region (50) bounded by a driving-side end (46) and a driven-side end (48), and measurement elements (52, 54, 56, 58) which are designed to measure a time difference, resulting from a deformation of the torsion region (50) in the rotation load mode, between driven-side end (48) and driving-side end (46).

### TECHNICAL FIELD

The present invention relates to a bottom bracket bearing, a method for detecting power on a bottom bracket bearing, an apparatus and a method for regulating an electric drive, and a vehicle, in particular muscle-driven, with driver torque detection.

### DESCRIPTION OF THE PRIOR ART

Vehicles that can be operated with muscle power with electric assistance are known from the prior art in various designs. In the case of vehicles of this kind, it is often desirable to determine a torsional moment or torque acting on a shaft. The effect of magnetostriction, magnetoelasticity or inverse magnetostriction or magnetoelasticity can be exploited here. This effect is due to the deformation of magnetic, especially ferromagnetic substances as a result of an applied magnetic field. A suitable body undergoes an elastic change in length at a constant volume. Conversely, in the case of inverted magnetostriction or magnetoelasticity, the magnetic properties are changed as a result of an applied change of length or shape. This can be exploited to determine the torque acting on a shaft. For this purpose, a part of the shaft is formed with or from a material that exhibits the effect of inverse magnetostriction or magnetoelasticity.

It is problematic, however, that there is a certain distance between this part of the shaft and a sensor designed to measure the magnetic field and the change thereof, because the sensor is arranged with a sensor holder outside the shaft to be measured. If the sensor and sensor shaft, i.e. the shaft of which the torque or torsional moment is to be determined, are not oriented relative to each other in a constant concentric manner, then static measurement deviations of the sensor signal may occur, which are caused by a different distance or air gap between the sensor and the sensor shaft. In addition, errors in the concentricity of the shaft and the coaxiality can also cause dynamic errors that have a negative effect on the sensor signal and the evaluation thereof.

From DE 37 22 728 C1 a power meter is known for a crank drive of a bicycle in which the pedaling force is converted into an electrical signal by the deformation of a suitable bending element. The bending element is a torsion bushing by means of which the torque from the crank is transmitted via the crank spindle and the torsion bushing to the drive pulley (the chainring). Strain gauges for detecting the deformation are applied to the torsion bushing.

WO 2010/037368 A1 discloses a bicycle bottom bracket bearing with a crankshaft and a chainring shaft in the form of a hollow shaft, which partially encloses the shaft and is connected to it so as to rotate with it. In a first magnetization region, a net torque fed into the hollow shaft is detected, which is compared with torque introduced into the shaft by the pedal cranks in a second magnetization region. The measurement is carried out magnetostrictively.

EP 3 325 930 B1 discloses a measuring arrangement for measuring the torque on a shaft with a torsion bushing which is connected via first and second gears to the shaft or to a gear element for the torque output. The torsional bushing is formed with or from a magnetostrictive or magnetoelastic material, and the changes resulting from a deformation of the torsion sleeve are measured by means of magnetic field sensors.

### SUMMARY OF THE INVENTION

On this basis, according to the invention, a bottom bracket bearing with the features of claim 1, a method for detecting power on a bottom bracket bearing of a muscle-power-driven vehicle having the features of claim 7, an apparatus for regulating an electric drive having the features of claim 9 as well as a muscle-powered vehicle having the features of claim 10 and a method for regulating an electrical drive of a muscle-powered vehicle with the characteristics of claim 11 are proposed.

The invention is based on the knowledge that for determining a power applied by means of muscle power, the cadence (i.e. the rotational speed of the bottom bracket bearing shaft) and the torque applied to the bottom bracket bearing shaft are detected. For this purpose, a torsion element connected to the bottom bracket bearing shaft so as to rotate with it is provided with a torsion region bounded by a drive end and an output end. For determining the torque, a deformation of the torsion region is detected during loaded operation by means of a precise time measurement. For carrying out the time measurement, at least one first measuring trigger is provided on the drive side and at least one second measuring trigger is provided on the driven side, which are offset relative to each other in the event of a deformation of the torsion region. The resulting time difference, together with the determined rotational speed (cadence), forms an indication of the present deformation of the torsion region and allows a calculation of the applied torque.

The approach according to the invention provides high measurement resolution. According to the invention, this results from the sampling rate with which the time between the measuring triggers can be detected. This sampling rate is determined by the clock frequency of a microcontroller used for processing and is usually in the MHz range (between 1-200 million clocks per second). The higher the resolution of the measured values, the more precise the motorized support to the respective driving situation can be. On the one hand, this improves driving comfort, but on the other hand, it also improves the efficiency of the support. This is particularly important in sporting applications.

Further advantages and designs of the invention can be found in the dependent claims, the description and the accompanying drawings.

A numbered list of aspects of the invention is reproduced below:
1. A bottom bracket bearing (40) with
   a bottom bracket bearing shaft (42),
   a torsion element (44) connected to the bottom bracket bearing shaft (42) so as to rotate with it with a torsion region (50) bounded by a drive-side end (46) and a driven-side end (48), and
   at least a first measuring trigger (52) arranged on the drive side and with at least a second measuring trigger (54) arranged on the driven side, each of which is assigned a first timer (56) and/or a second timer (58).
2. The bottom bracket bearing (40) according to aspect 1, the measuring triggers of which (52, 54) are designed to measure, by means of the assigned first and second timers (56, 58), a time offset between the first measuring trigger (52) and the second measuring trigger (54) resulting from a load-related distortion of the torsion region (50) arising under the action of a torque.
3. A bottom bracket bearing (40), in particular according to aspect 1, with a bottom bracket bearing shaft (42),
   a torsion element (44) connected on the drive side to the bottom bracket bearing shaft (42) so as to rotate with it with a torsion region (50) bounded by a drive-side end (46) and a driven-side end (48)
   and measuring elements (52, 54, 56, 58), which are designed to measure a time difference between the driven-side end (48) and the drive-side end (46) resulting from the deformation of the torsion region (50) in the rotational load mode.
4. The bottom bracket bearing (40) according to aspect 3, wherein the measuring elements (52, 54, 56, 58) include at least one first measuring trigger (52) arranged on the drive side and with at least one second measuring trigger (54) arranged on the driven side, each with an assigned first timer (56) and/or second timer (58).
5. The bottom bracket bearing (40) according to one of the above aspects, wherein the first and second timers (56, 58) are stationary.
6. The bottom bracket bearing (40) according to one of the above aspects, which has a measuring arrangement (60, 62) for measuring a revolution rate or rotational speed of the bottom bracket bearing shaft (42).
7. The bottom bracket bearing (40) according to one of the above aspects, which, for determining the revolution rate or rotational speed of the bottom bracket bearing shaft (42), has a pulse generator (60) arranged on the drive side with an assigned stationary incremental encoder (62).
8. The bottom bracket bearing (40) according to one of the above aspects, wherein a first or second measuring trigger (52, 54) with an associated timer (56, 58) is used for determining a revolution rate or rotational speed of the bottom bracket bearing shaft (42).
9. The bottom bracket bearing (40) according to one of the above aspects, wherein the at least one first measuring trigger (52) is placed on the circumference of an outer surface of the bottom bracket bearing shaft (42) or on an outer surface of the drive-side end (46) of the torsion element (44).
10. The bottom bracket bearing (40) according to one of the above aspects, wherein the at least one second measuring trigger (54) is mounted on the circumference of an outer surface of the driven-side end (48) of the torsion element (44).
11. The bottom bracket bearing (40) according to one of the above aspects, wherein the at least one first measuring trigger (52) and the at least one second measuring trigger (54) are axially aligned with each other.
12. The bottom bracket bearing (40) according to one of the above aspects, wherein a plurality of first measuring triggers (52) and, in particular, a correspondingly equal number of second measuring triggers (54) are provided.
13. The bottom bracket bearing (40) according to one of the above aspects, wherein overload protection is provided in the form of a torsion limit, in particular a torsion limit of the torsion element (44) relative to the bottom bracket bearing shaft (42) extending through the torsion element (44).
14. The bottom bracket bearing (40) according to aspect 13, wherein the torsion limit is formed by at least one stop element, which is spaced apart in the direction of torsion from at least one assigned stop.
15. The bottom bracket bearing (40) according to aspect 13 or 14, wherein the bottom bracket bearing shaft (42) has a non-circular external cross-section and the torsion element (44) has a complementary internal cross-section, or wherein at least one pin is provided which is connected to the bottom bracket bearing shaft (42) or the torsion element (44) so as to rotate therewith and which is inserted into a bore provided for this purpose of the corresponding other element-torsion element (44) or bottom bracket bearing shaft (42)—so as to be spaced apart by a gap.
16. The bottom bracket bearing (40) according to one of aspects 13 to 15, wherein the torsion limit defines a measuring range of the measuring elements (52, 54, 56, 58).
17. The bottom bracket bearing (40) according to one of the aspects 12 to 16, the first measuring triggers (52) of which are distributed on a circumference of the bottom bearing bracket shaft (42) and protrude through recesses (53) provided for this purpose between the second measuring triggers (54) arranged radially offset to the first measuring triggers (52) on a circumference of the driven-side end (48) of the torsion element (44), so that an alternating arrangement of first and second measuring triggers (52, 54) is created.
18. The bottom bracket bearing (40) according to one of the above aspects, wherein the first measuring triggers (52) and/or the second measuring triggers (54) are formed in one piece with the bottom bracket bearing shaft (42) or the torsion element (44).
19. The bottom bracket bearing (40) according to one of the above aspects, which includes evaluation electronics formed in particular on a circuit board (64), wherein the circuit board is preferably arranged in or on a wall of a bottom bracket bearing housing (66).
20. The bottom bracket bearing (40) according to one of the above aspects, wherein at least one first measuring trigger (52) and at least one second measuring trigger (54) are designed in such a way that the radially outward-facing surfaces thereof are essentially at the same level.
21. The bottom bracket bearing (40) according to one of aspects 17 to 20, wherein the overload protection is formed by the recesses (53).
22. The bottom bracket bearing (40) according to one of the above aspects, which contains a reference marker assigned to the bottom bracket bearing shaft for determining the position of the bottom bracket bearing shaft.
23. A method for detecting power on a bottom bracket bearing (40) of a muscle-powered vehicle (10), which contains a torsion element (44) connected so as to rotate therewith to a bottom bracket bearing shaft (42) of the bottom bracket bearing (40) on the drive side with a torsion region (50) limited by a drive-side end (46) and a driven-side end (48), wherein a load-induced deformation of the torsion region (50) is determined by means of a measurement of a time offset between the driven-side end (48) and the drive-side end (46) arising under the action of a torque and a measurement of a rotational speed of the bottom bracket bearing shaft (42).
24. The method according to aspect 23, wherein a measuring region is defined by a torsion limit at the driven-side end (48) of the torsion element (44).
25. The method according to aspect 23 or 24, wherein the time offset is determined by means of a first measuring trigger (52) on the drive side and a second measuring trigger (54) on the driven side.
26. The method according to aspect 25, wherein the time measurement is triggered by a first measuring trigger (52) and terminated by an associated second measuring trigger (54).
27. The method according to aspect 26, wherein the first and the second measuring triggers (52, 54) have an axially aligned position relative to each other defined in the rest state, or wherein the first and second measuring triggers (52, 54) have a radially alternating position relative to each other defined in the rest state.
28. An apparatus (100) for regulating an electric drive (22) of a muscle-powered vehicle (10), with
   a power electronics module (110) that calculates a control variable for a motor current to be supplied to the drive (22) based on an input command variable reflecting a target acceleration,
   an accelerometer (120) for measuring an actual acceleration of the vehicle (10) and, in particular, for determining a position of the vehicle (10), and
   a comparison element (130) for comparing the actual acceleration with the target acceleration,
   wherein the input command variable is calculated from a mechanically applied power measured at a bottom bracket bearing (40) of the vehicle (10) and the input command variable is fed into the comparison element (130) as the target value and the actual acceleration of the vehicle (10) measured by the accelerometer (120) is fed in as the actual value.
29. A vehicle (10) with a bottom bracket bearing (40) according to aspects 1 to 22.
30. The vehicle (10), in particular according to aspect 29, with an apparatus according to aspect 28 and a sensor for detecting a mechanically applied power.
31. A vehicle (10) according to aspect 29 or 30, which is a muscle-powered land, water or air vehicle, such as a bicycle, an electric bicycle, a pedelec, a small electric vehicle or similar with in particular two or more wheels or an ergometer, a pedal boat or the like.
32. A method for regulating an electric drive (22) of a muscle-powered vehicle (10), with the following steps:
   Determining a mechanically applied power detected on a bottom bracket bearing (40) of the vehicle (10), in particular by means of a method according to one of the aspects 23 to 27, and on the basis thereof the calculation of a target acceleration,
   Determining an actual acceleration of the vehicle (10) and, if applicable, a position of the vehicle,
   Comparing a target acceleration and the actual acceleration in a comparison element for generating an input command variable for the regulation,
   Calculating, on the basis of the input command variable, a control variable for a motor current to be supplied to the drive (22).

It is understood that the above-mentioned features and the features to be explained below can be used not only in the combination specified in each case, but also in other combinations or in isolation, without departing from the scope of the present invention.

The invention is illustrated highly schematically in the drawing on the basis of exemplary embodiments and is described in detail below with reference to the drawing.

### BRIEF DESCRIPTION OF THE DRAWINGS

FIG. 1 shows a highly schematic representation of an electric bicycle with a bottom bracket bearing according to the invention.

FIG. 2 shows in a schematized lateral representation a cross-section through a bottom bracket bearing according to the invention parallel to a longitudinal axis of the pedal crankshaft thereof.

FIGS. 3a to 3c show, in a schematic cross-sectional view perpendicular to the longitudinal axis of the pedal crankshaft according to the section line III-III of FIG. 2, a sequence for illustration of the relative displacement of the first and second measuring triggers according to the invention in the load state.

FIG. 4 shows in a perspective representation a bottom bracket bearing shaft with a torsion sleeve of another embodiment of a bottom bracket bearing according to the invention.

FIG. 5 shows an enlarged detail of FIG. 4 in a sectional view according to the section line V-V.

FIGS. 6a to 6c show similarly to the illustration of FIGS. 3a to 3c a sequence for illustrating the relative displacement of the first and second measuring triggers according to the invention in the load state according to the principle of the embodiment of FIGS. 4 and 5.

FIG. 7 shows a block diagram of an apparatus according to the invention for acceleration-dependent regulation of an electric drive of a muscle-powered electric vehicle.

FIG. 8 shows in a side view the bottom bracket bearing shaft of the exemplary embodiment of FIG. 2 without the bottom bracket bearing housing.

FIG. 9 shows a section through the bottom bracket bearing shaft of FIG. 4 according to the section line IX-IX for illustration of the overload protection.

FIG. 10A shows a variant of the overload protection similarly to the illustration of FIG. 9.

FIG. 10B shows the overload protection of FIG. 10A at the stop.

FIG. 11 shows another variant of the overload protection similarly to the illustration of FIG. 9.

FIG. 12A shows another variant of the overload protection similarly to the illustration of FIG. 9.

FIG. 12B shows the overload protection of FIG. 12A at the stop.

### DETAILED DESCRIPTION

Identical and similar features depicted in the individual figures are marked with the same reference signs.

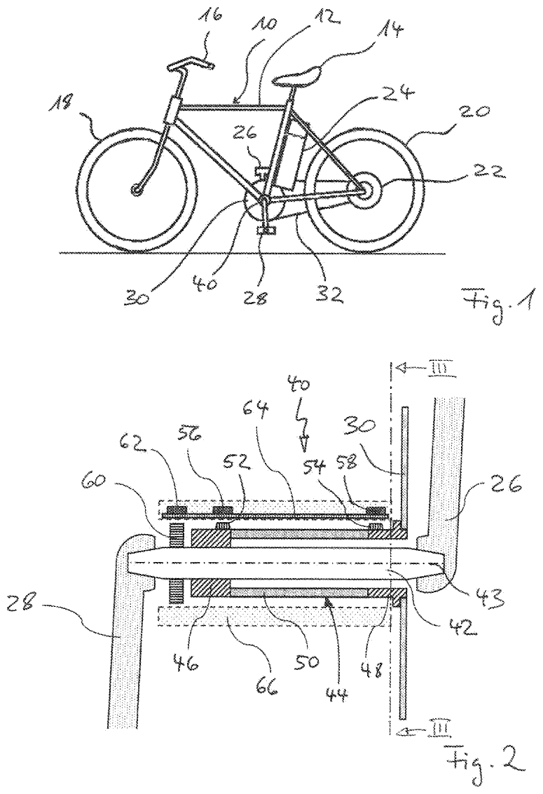

FIG. 1 shows an electric bicycle 10 by way of example as a possible embodiment of a muscle-powered vehicle according to the invention. The electric bicycle includes, in a well-known way, a frame 12 with a saddle 14, a handlebar 16, a front wheel 18, and a rear wheel 20. The rear wheel has a hub motor 22 as an electric drive. A battery 24 is provided for supplying power to the hub motor 22. Of course, the invention is also suitable in connection with other propulsion arrangements, such as a so-called mid-mounted motor integrated directly into the bottom bracket bearing area. The necessary design adaptations for the various possible applications are in the realm of professional skills.

The bicycle also contains a crank drive with a bottom bracket bearing 40 according to the invention mounted in the frame 12 as well as a right crank 26 and a left crank 28. A drive torque, which is provided by a rider, is transmitted by a chainring 30 on the crank drive to a chain 32 on a pinion of the rear wheel. An unspecified control unit is for example arranged on the handlebar 16 or near the battery 24 of the bicycle and is connected to the electric drive 22.

FIG. 2 shows the bottom bracket bearing 40 according to the invention in a lateral sectional representation. The sectional plane runs vertically through a longitudinal axis 43 of a bottom bracket bearing shaft 42 of the bottom bracket bearing 40. The bottom bracket bearing shaft 42 is designed to accommodate a crank (right crank 26, left crank 28) at its longitudinally opposite ends. FIG. 8 shows the bottom bracket bearing shaft 40 of FIG. 2 in a lateral view without cranks 26, 28.

According to the invention, the bottom bracket bearing 40 contains a torsion element 44. The torsion element 44 can as shown be designed as a torsion sleeve or torsion bushing. The torsion element 44 has a first, drive-side end 46 and a second, driven-side end 48. The first end 46 and the second end 48 bound a torsion region 50. The torsion region is designed to be able to be twisted in a suitable manner, i.e. it undergoes a defined deformation when a torque or load is applied. For this purpose, the torsion region can be made for example of another material of lower torsional rigidity and/or of a section of lower material thickness and/or consist of a section with material cut-outs such as gaps, slots, holes and/or a section of folded material.

As can be seen from the illustration of FIG. 2, the torsion element 44 is connected at the drive-side end 46 to the bottom bracket bearing shaft 42 so as to rotate therewith. For the manufacture of the rotationally fixed connection, techniques such as welding, soldering, gluing, etc. known to the person skilled in the art can be used. A one-piece design of a bottom bracket bearing shaft 42 and a torsion element 44 can prove to be advantageous. The bottom bracket bearing shaft 42 and the torsion element 44 consist for example of a high strength material, for example stainless steel or titanium.

The driven-side end 48 of the torsion element 44 is designed to accommodate a driven element such as the chainring 30 or similar (belt drive, shaft drive, toothed wheel or spur gear drive, etc.). In contrast to the drive-side end 46, the driven-side end 46 is not connected to the bottom bracket bearing shaft 42, but only to the driven element 30. When a load is applied with the shaft 42 rotating (exertion of a torque on the cranks 26, 28 by a rider), there is therefore a deformation of the torsion region 50 between the drive-side end 46 and the driven-side end 46.

In order to be able to measure this deformation and use it as a basis for determining the torque, at least a first measuring trigger 52 arranged on the drive side and at least a second measuring trigger 54 arranged on the driven side are provided as measuring elements according to the invention. In the embodiment of FIGS. 2 and 8, the first measuring trigger 52 is attached to the drive-side end 46 of the torsion element 44 and the second measuring element 54 is attached to the driven-side end 46. The measuring triggers 52, 54 are attached to the outer circumference of the torsion element 44. In the case of a one-piece design, the bottom bracket bearing shaft and the torsion element together with the measuring triggers formed on it are made of a ferromagnetic material if an inductive measurement is required.

The measuring triggers 52, 54 are assigned first and second timers 56, 58 (cf. FIG. 2). The timers 56, 58 can be arranged as shown for example in or on a bottom bracket bearing housing (which is not reproduced in the illustration of FIG. 8 for the sake of clarity) that accommodates the bottom bracket bearing shaft and the torsion element 66. In addition, the timers 56 and 58 can also be mounted on a circuit board 64 with evaluation electronics as shown. The circuit board 64 can be integrated for example in a wall of the housing 66.

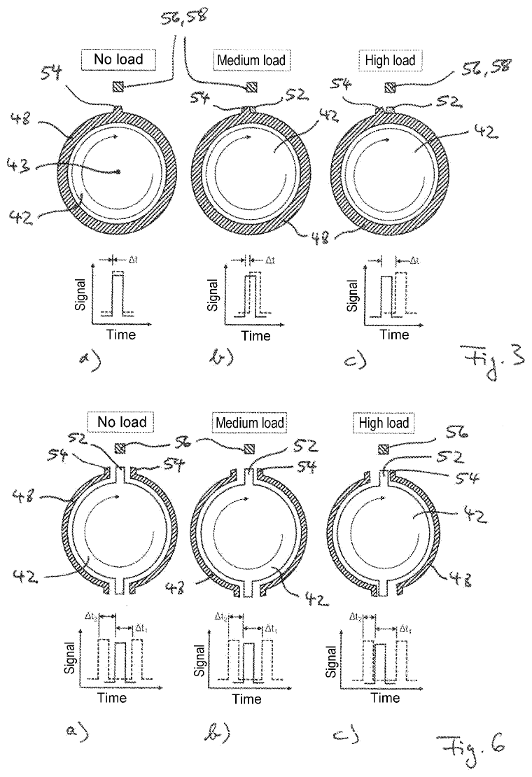

In operation, the bottom bracket bearing shaft 42 rotates due to a torque generated by the input of muscle power via the cranks 26, 28. In the exemplary embodiment shown in FIG. 2, the first and second measuring triggers 52, 54 are axially aligned relative to each other (see also the following explanation in connection with FIG. 3). The axial alignment is not mandatory, but it is sufficient if the measuring triggers occupy a known or defined position in relation to each other in the rest state, which can be taken into account (deducted) when calculating the time offset.

A variety of first and second measuring triggers can also be provided, for example distributed around the torsion sleeve, especially at suitable equal distances or equidistantly. For reasons of clarity, only a first and a second measuring trigger are shown in the depiction of FIGS. 2 and 3.

The first measuring trigger(s) 52 is/are assigned a first timer 56 and the second measuring trigger(s) 54 is/are assigned a second timer 58. The timers are also axially aligned with each other (like the measuring triggers) and are arranged vertically above the bottom bracket bearing shaft in the embodiment of FIGS. 2 and 3. The timers are arranged in a position relative to each other which corresponds to the relative position of the measuring triggers in the resting or load-free state.

A time measurement according to the invention is triggered when the first measuring trigger 52 passes the assigned first timer 56. The time measurement is stopped when the second measuring trigger 54 passes the assigned second timer 58.

In order to prevent overstretching of the torsion element 44 in torsional operation, according to the invention an overload protection in the form of a twist limiter can be provided. With this exceeding the so-called elastic limit of the torsion element can be prevented. If the elastic limit is exceeded, an irreversible plastic deformation occurs, which would require recalibration or impair the function of the sensor or even nullify it altogether.

Furthermore, the measuring range, i.e. the resolution, of the sensor, can be adjusted by means of the twist limiter. The measuring range corresponds to the twisting movement of the torsion element at the driven-side end starting from the rest state up to the stop. The twisting movement is chosen to lie within the elastic range of the torsion element.

The twist limiter can be realized by providing a stop element that is arranged spaced apart from at least one assigned stop in the torsion direction.

The stop elements and the stops can be realized for example by means of a suitable geometrical design of the cross-sections of the bottom bracket bearing shaft 42 and the torsion element 44, for example by means of non-circular cross-sections. The measuring range can be adjusted by the appropriate selection and coordination of geometry and spacing or gap size.

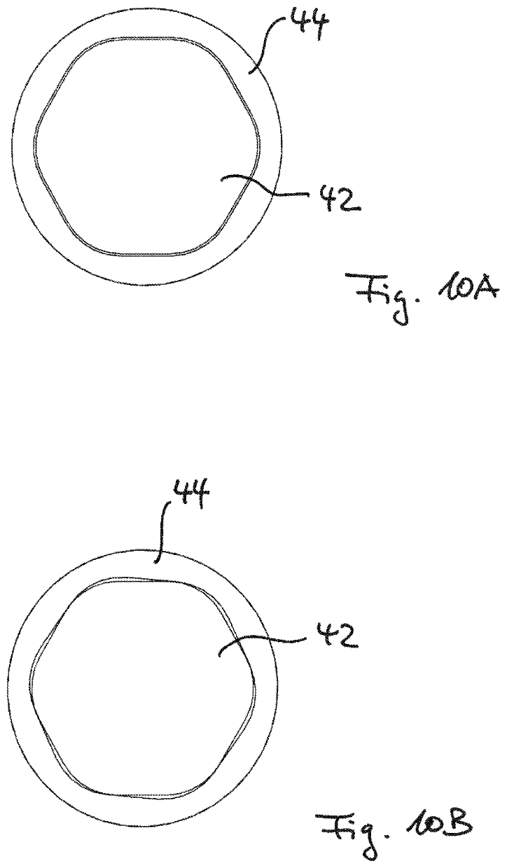

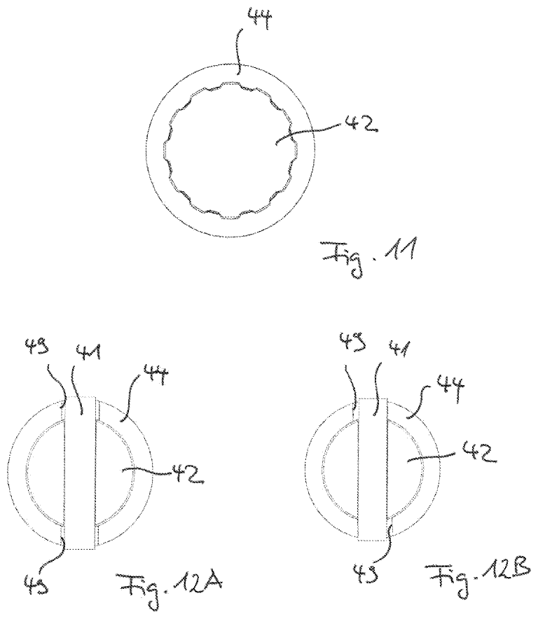

FIG. 9 illustrates a first variant of such a twist limiter in a schematic sectional diagram according to the section line IX-IX of FIG. 8. In the exemplary embodiment shown, the bottom bracket bearing shaft 42 has an essentially square external cross-section with rounded corners. The torsion element 44 has an internal cross-section of complementary form, so that when correctly oriented the torsion element 44 can envelop the bottom bracket bearing shaft 42 with a small, defined gap 45. FIGS. 10/10B and 11 show similar designs with an internal cross-section of the torsion element 44 matched to an external cross-section of the bottom bracket bearing shaft 42. In the further variant of FIG. 10A, the cross-section is hexagonal instead of quadrilateral (as in the example of FIG. 9), and in the still further variant in FIG. 11, the internal and external cross-sections interlock in a manner similar to toothed wheels.

All the variants shown in FIGS. 9 to 11 have twist limiters by means of the described spacing of the cross-sections (gap 45) in the non-twisted rest position of the torsion element. If torsion/deformation of the torsion element 44 occurs during load operation, the internal cross-section of the torsion element 44 twists relative to the external cross-section of the bottom bracket bearing shaft 42, so that the gap 45 is no longer uniform. In the case of strong deformation, this leads to the internal cross-section of the torsion element 44 encountering the external cross-section of the bottom bracket bearing shaft 42 at certain points, as illustrated schematically in the illustration of FIG. 10B. From this moment on, the overload protection is effective, as further twisting of the torsion element 44 is prevented.

In FIGS. 12A and 12B another variant of a twist limiter according to the invention is presented. In this design, the bottom bracket bearing shaft 42 has a stop pin 41 inserted so as to rotate with it or in one piece as a stop element, which with the opposite ends thereof protrudes from the (in this case circular) external cross-section of the bottom bracket bearing shaft 42 in such a way that these ends engage with bores 49 which are designed for this purpose and are aligned with the pin in the non-twisted rest state. The walls of the boreholes are used as stops. The engagement of the pin ends in the bores 49 is carried out with spacing gaps, so that, as in the variants described above, there is circumferential backlash. This circumferential backlash ensures a defined twisting/deformation of the torsion element 44 until the pin ends encounter the walls of the bores 49 (cf. FIG. 12B)—this is the moment when the overload protection, i.e. the twist limiter, takes effect. A kinematic reversal with at least one pin connected to the torsion element so as to rotate therewith and engaging in a bore provided for this purpose in the bottom bracket bearing shaft is also conceivable.

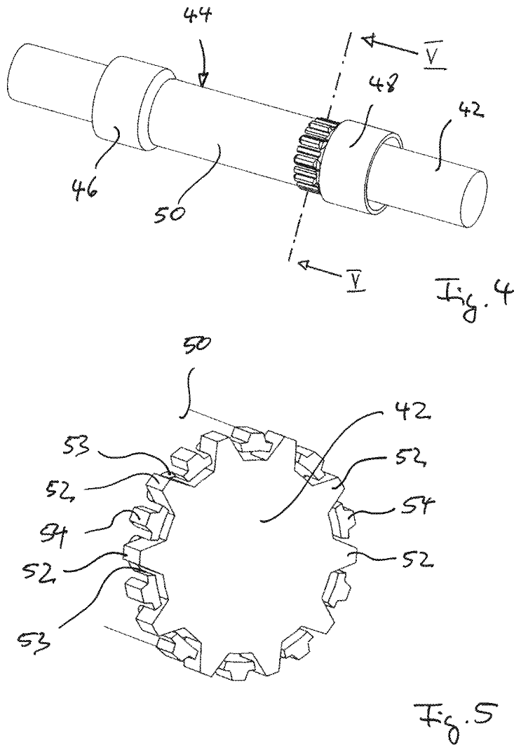

A further twist limiter according to the invention is described below in connection with the exemplary embodiment of FIGS. 4 and 5. Other alternative designs based on the principle described of twist limiting of the torsion element or torsion sleeve or bushing relative to the bottom bracket bearing shaft extending through the torsion element are readily apparent to the person skilled in the art, i.e. the presence of a stop element which is arranged at a gap distance from a stop in the torsion direction.

Of course, the gaps in the described variants of overload protection in the rest state do not have to be ideally symmetrical or uniform as shown. In extreme cases, there may be contact in the opposite direction even in the rest state, provided that there is a defined twisting of the torsion element up to the twist limiter taking effect.

The mode of operation of the bottom bracket bearing according to the invention is shown in the sequence of FIGS. 3a to 3c. FIG. 3 (FIGS. 3a, 3b, 3c) shows a very simplified cross-sectional view in the direction of the longitudinal axis 43 of the bottom bracket bearing shaft 42 according to the section line III-III of FIG. 2.

The illustration on the left (FIG. 3a) shows the arrangement of the bottom bracket bearing shaft 42 and the torsion sleeve 44 or the driven-side end 48 thereof in the unloaded state. This can be the rest state or even idling (rotation without load or torque). In this state, the first and second measuring triggers are 52, 54 are axially aligned with each other (i.e. the first measuring trigger 52 cannot be seen in the illustration of FIG. 3a, as it is behind the second measuring trigger 54).

In the case of time measurement as described above (triggering by the first timer, termination by the second timer), no time difference is determined in the load-free state of FIG. 3a, i.e. Δt=0, as illustrated in the diagram of FIG. 3a (if the measuring triggers are not exactly aligned with each other or if there is a defined angular position between them, a time difference is of course determined, but the time difference in the load-free state is subtracted from this, so that again Δt=0). In the respective schematic diagram shown below the sectional diagrams, the SOLID LINE signal curve is the curve generated by the first measuring trigger 52 (on the drive side) and the dashed signal curve is the curve generated by the second measuring trigger 54 (driven side). The two curves are drawn slightly offset in height for better recognizability. It is a purely qualitative, schematic signal curve for illustration purposes. In particular, the rotational speed is not taken into account in the signal representation (as the revolution rate increases, the time between the rising and descending edges of the signal decreases, so the signal becomes “thinner”).

As the load increases in the direction of rotation of the bottom bracket bearing shaft (arrow shown), deformation of the torsion region 50 occurs so that the driven-side end 46 of the torsion sleeve 44 “lags behind” the drive-side end 46. This, in turn, has the consequence that the first measuring trigger 52 runs through under the respective assigned timer 56 or 58 before the second measuring trigger 54. This offset is then reflected in the time difference Δt>0 measured according to the invention, which becomes greater with increasing load (commonly known as torque) (cf. the diagram sequence of FIGS. 3b and 3c). The time offset between the signals (as in this case, for example, the time offset between the rising edges of the two signals) is the variable determined according to the invention.

In addition, according to the invention, the revolution rate or rotational speed of the bottom bracket bearing shaft is measured. For this purpose, according to the invention, a measuring arrangement for measuring a revolution rate or rotational speed of the bottom bracket bearing shaft can be provided. In the exemplary embodiment of FIG. 2, this measuring arrangement contains a pulse generator 60 which, as shown, may be connected to the bottom bracket bearing shaft 42 so as to rotate therewith, and an assigned stationary attached incremental encoder 62. The incremental encoder 62 can be arranged like the first and second timers 56, 58 for example in or on the bottom bracket bearing housing 66. The pulse generator 60 can be formed in one piece with the bottom bracket bearing shaft 42. The pulse generator 60 can be in the form of a sprocket.

Arrangements other than the one shown are possible and are within the skill range of persons skilled in the art. For example, the pulse generator 60 can also be arranged (in addition to the first measuring trigger 52) on the drive-side end 46 of the torsion sleeve 44. In addition, the pulse generator 60 could also, for example, be arranged (in addition to the second measuring trigger 54) on the driven-side end 46 of the torsion sleeve 44, provided that the revolution rate can be determined here with sufficient accuracy. Finally, for example, the pulse generator 60 instead of the first measuring trigger(s) 52 could be arranged on the torsion sleeve 44, while the first measuring trigger(s) 52 could be arranged on the bottom bracket bearing shaft 44.

Alternatively, the revolution rate measurement function can be performed, for example, by one of the measuring triggers, in particular the first measuring trigger(s), so that there is no need for a separate measuring arrangement for measuring a revolution rate or rotational speed. In particular, for example, the width of the square-wave signal can be used to infer the revolution rate.

When the shaft rotates, the rotational speed thereof is detected in real time by means of the incremental encoder 62 and transmitted to the evaluation electronics for processing. The time difference measured by the first and second measuring triggers is also fed into the evaluation electronics and reveals in relation to the rotational speed of the drive shaft a statement about the present deformation of the torsion region. This can now be converted into a torque, which results in the applied power in a final calculation step through the evaluation electronics with the further help of the rotational speed.

A significant advantage of the apparatus according to the invention is a very high measurement resolution. According to the invention, this results from the sampling rate with which the time between the first and second measuring triggers can be detected. This sampling rate is determined by the clock frequency of a microcontroller of the evaluation electronics and is usually in the MHz range (between 1-200 million clocks per second). The higher the resolution of the measured values, the more precisely the motor support can be adapted to the respective driving situation. This improves the driving experience on the one hand, but also the efficiency of the support on the other. This is particularly important in sporting applications.

Another advantage of the invention is that the torque can differ between forward and rearward loads while the direction of rotation remains the same. This makes it possible to detect a braking force in the event of a reversal of thrust, for example when braking with a fixie (bicycle with a fixed gear ratio without a freewheel). This results in a control variable for energy recovery for recuperative braking by a motor.

Another advantage according to the invention is the fact that the torque can be specifically detected where the relevant pressure points result from pedaling stroke in relation to a revolution of the crank. By means of a varying number and targeted location of the measuring triggers, the mechanical design allows the method to be tailored specifically to the respective application.

A design of a bottom bracket bearing according to the invention is shown in FIGS. 4 and 5. In this embodiment, the first measuring triggers—as already indicated above—are not arranged at the drive-side end 46 of the torsion sleeve 44, but on the drive side directly on the bottom bracket bearing shaft 42. In particular, the first measuring triggers 52 (as shown) can be designed in one piece as radially protruding ring elements.

The second measuring triggers 54 are arranged circumferentially on the torsion sleeve 44 in a transition region between the torsion region and the driven-side end 46 of the torsion sleeve 44 that is designed to accommodate the output element (chainring) 30. As shown, the second measuring triggers 54 can also be formed in one piece with the torsion sleeve 44.

Between the second measuring triggers 54 there are recesses 53 which are dimensioned in such a way that the first measuring triggers 52, which are below in the assembled state of the bottom bracket bearing arrangement, protrude through the recesses 53. As a result, the first measuring triggers 52 protruding through the recesses 53 are radially offset from the second measuring triggers 54. There is an alternating arrangement of first and second measuring triggers 52, 54 in the circumferential direction of the bottom bracket bearing shaft.

If the first measuring triggers are arranged or formed on the shaft and if the second measuring triggers are arranged or formed on the torsion sleeve, the measuring triggers may be designed in such a way that the surfaces thereof are radially located essentially at the same height (i.e. in relation to the bottom bracket bearing longitudinal axis 43), or in other words are essentially at the same distance from the bottom bracket bearing longitudinal axis.

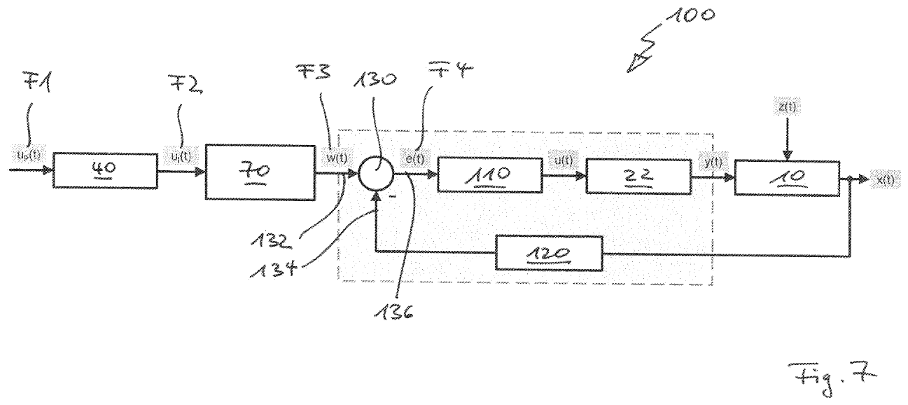

In this design, if the torsion sleeve 44 is subject to torsion, the first and second measuring triggers 52, 54 shift relative to each other, as illustrated by the sequence of FIGS. 6a to 6c. In FIG. 6 (FIGS. 6a, 6b, 6c) only an upper and a lower alternating arrangement of measuring triggers are drawn for the purpose of simpler presentation and better illustration.

For time difference measurement according to the invention, only one stationary timer 56 radially outside of the measuring triggers is necessary. As before in connection with FIG. 3, the solid signal curve is the curve generated on the drive side and the dashed signal curve is curve generated on the driven side. The two curves are drawn slightly offset in height for better distinguishability.

In the load-free state, this arrangement of measuring triggers results in a regular sawtooth pattern of two signal curves mutually offset by half a period (cf. schematic diagram of FIG. 6a with a time difference Δt₂ between the ascending drive-side flank and the leading ascending driven-side flank (which is triggered by the second measuring trigger 54 on the left in the illustration of FIG. 6) and a time difference Δt₁ between the ascending drive-side flank and the subsequent ascending driven-side flank (which is assigned the second measuring trigger 54 on the left in the illustration of FIG. 6), wherein: Δt₁=Δt₂).

As the load increases as a result of the torsion of the torsion region, the distance between passing the first measuring trigger 52 and passing the subsequent second measuring trigger 54 increases, while accordingly the distance between passing the first measuring trigger 52 and passing the leading second measuring trigger decreases, so that Δt₁>Δt₂ with Δt₁+Δt₂=const. assuming a constant revolution rate (cf. sketches of FIGS. 6b and 6c). At the same time, this arrangement results in overload protection, as described above, once the first measuring triggers 52 (which form the stop elements here) formed on the shaft 42 contact the recesses 53 of the sleeve 44 that act as stops (twist limiter).

The described design of FIGS. 4 to 6 with offset measuring triggers can also be used to increase (double) the measurement resolution by forming the difference between Δt₁ and Δt₂, i.e. D=Δt₁−Δt₂, wherein D is always twice as much for a given load compared to a consideration of only the difference between Δt₁ and the load-free Δt₁ or Δt₂ and the load-free Δt₂. The same principle can also be realized with the design of FIGS. 2 and 3, in that the first and the second measuring triggers can be offset radially relative to each other, for example by a tooth width. Such an arrangement is also an arrangement with radially alternating positions according to aspect 23 above, which, however, do not alternate equidistantly, whereas the measuring triggers of FIGS. 4 and 5 are arranged alternating equidistantly.

The measuring elements for measuring the time difference between the driven-side end and the drive-side end (measuring trigger and timer) resulting from a deformation of the torsion region in rotational load operation can be triggered electrically, inductively, optically or acoustically. Likewise, the measuring arrangement for measuring a revolution rate (pulse generator and incremental encoder) can be implemented electrically, inductively, optically or acoustically.

The pulse generator can have a reference marker (this applies correspondingly if the function of the pulse encoder is fulfilled by a measuring trigger). As a result, the position of the bottom bracket bearing shaft and thus the right and left crank position can be determined after a maximum of one revolution. In this way, the torque can be positively assigned to the right and left cranks. The incremental encoder can detect the revolution rate and the direction of rotation.

The number of measuring triggers can vary as desired. For double-sided measurements, at least four measuring triggers (i.e. two pairs of measuring triggers) are provided; two first measuring triggers on the drive side and two second measuring triggers on the driven side, offset by 180° and aligned with the respective crank.

The torsion region of the torsion sleeve may be formed variously in one or two parts with the ends of the torsion sleeve, made of the same material or a different material, for example slotted, perforated, folded, as an elastomer, steel, aluminum, copper, wood or the like.

The torsion sleeve can be formed with a ring-shaped cross-section as shown, but other forms are also possible, for example of one or more rectangular bending elements.

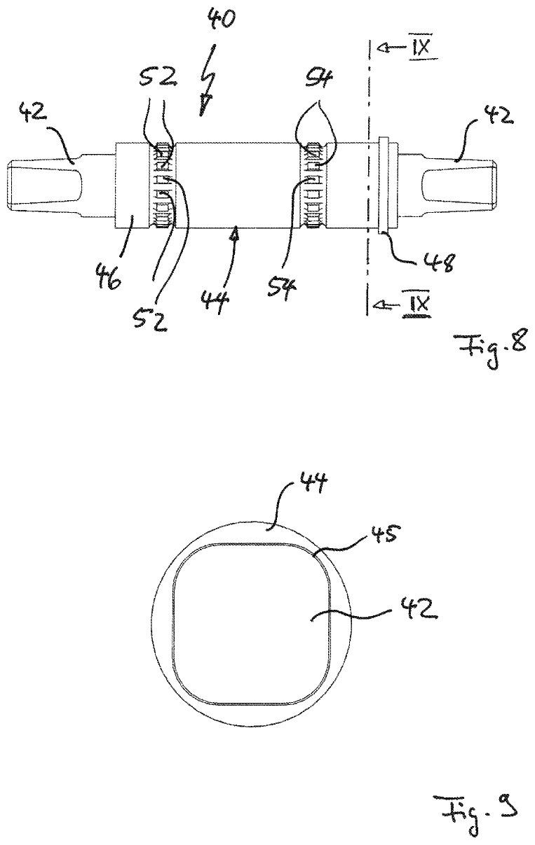

FIG. 7 shows a block diagram of an apparatus 100 for acceleration-dependent control of an electric drive 22 of a muscle-powered electric vehicle 10, hereinafter referred to as a motor controller 100 for short. By means of the motor controller 100, a drive torque provided by muscle power is specifically supported by the electric drive 22, also known as the auxiliary motor, in order to facilitate the drive of the vehicle 10. The torque introduced by muscle power can, in particular, be detected as described above.

The motor controller 100 contains a power electronics module 110, an accelerometer 120 and a comparison element 130. The accelerometer 120 is designed to measure an actual acceleration (actual acceleration) F8 (functional variable x(t)) of the vehicle 10. This actual variable is converted into a second input 134 of the comparison element 130. In addition, the accelerometer can also determine the position of the vehicle 10 in space. The term “position” here in particular means the inclination of the vehicle relative to the horizon, i.e. the determination of a positive or negative gradient while driving.

In a first input 132 of the comparison element 130, a target value for the acceleration is supplied as the input command variable. The input command variable is for example calculated as described above from a mechanically applied power (torque) FI (function variable Uₚ(t) detected on the bottom bracket bearing 40 of the vehicle 10; see also table below). For this purpose, for example in the evaluation electronics 40 of the bottom bracket bearing or in a characteristic field module 70 of the control device, based on a measurement signal for the torque and, if applicable, a vehicle position, as a power requirement F2 (function variable u₁(t)) based on a driver power-acceleration characteristic field, a command variable F3 for the desired acceleration (target acceleration) is calculated (function variable w(t)), which is fed into the first input 132 of the comparison element 130 as already described. The characteristic field module 70 determines the target acceleration depending on the requirement, i.e. depending on a set, predetermined or predeterminable driving profile of the vehicle (cargo bicycle, touring bicycle, mountain bicycle) and/or depending on profiles that can be selected by the driver. The position of the vehicle detected by the accelerometer is mapped by the characteristic field and taken into account when determining the power requirement. The location or inclination thus influences the characteristic field for determining the target acceleration.

At the output of the accelerometer 120 as a measuring device, the actual acceleration as a manipulated variable is fed into the second input 134 of the comparison element 130 as described. At an output 136 as a manipulated variable F4 for the power electronics module 110 there is the difference between the target acceleration and the actual acceleration (function variable e(t)). At an output of the power electronics module 110 as a control variable F5 there is a voltage or a current (function variable u(t)), which is applied to the auxiliary motor 22. An output shaft of the motor 22 provides motor support F6 (function variable y(t)) for the vehicle 10. Possible disturbance variables F7 are parameters acting as driving resistance, such as payload, incline, headwind, rolling resistance, etc. (Function variable z(t)).

| Function | | | |
|---|---|---|---|
| variable | Term | Description | Unit |
| Uₚ(t) | Control variable | Mechanically applied power | P_{Fahrer} |
| | | of the driver | |
| U₁(t) | Control variable | Power demand in the form of a | U_{PF} |
| | | measurement signal | |
| w(t) | Command variable | Desired acceleration for a given driver | a(P_{Fahrer}) |
| | | input | |
| e(t) | Control error | Difference between target and | A_{DIFF} |
| | | actual accelerations | |
| u(t) | Control variable | Motor current | I_{Motor} |
| y(t) | Manipulated | Auxiliary motor drive power | P_{Motor} |
| | variable | | |
| z(t) | Disturbance | Driving resistance (Load, gradient and | F_{FW} |
| | variable | headwind) | |
| x(t) | Controlled variable | Actual acceleration of the vehicle | A_{IST} |

1. A bottom bracket bearing (40), comprising;
a bottom bracket bearing shaft (42),
a drive side torsion element (44) connected to the bottom bracket bearing shaft (42) to rotate therewith with a torsion region (50) limited by a drive-side end (46) and a driven-side end (48), and
measuring elements (52, 54, 56, 58), which measure a time difference between the driven-side end (48) and the drive-side end (46) resulting from a deformation of the torsion region (50) during rotational load operation.

2. The bottom bracket bearing (40) of claim 1, wherein the measuring elements (52, 54, 56, 58) include at least one first measuring trigger (52) arranged on a drive side of the torsion element (44) and at least one second measuring trigger (54) arranged on a driven side of the torsion element (44), each with an assigned first timer (56) and/or second timer (58).

3. The bottom bracket bearing (40) of claim 1, wherein overload protection in the form of a twist limiter is provided, said twist limiter limiting twisting of the torsion element (44) relative to the bottom bracket bearing shaft (42) extending through the torsion element (44).

4. The bottom bracket bearing (40) of claim 3, wherein the twist limiter is formed by at least one stop element, which is arranged spaced apart in a torsion direction from at least one assigned stop.

5. The bottom bracket bearing (40) of claim 3, wherein the twist limiter defines a measuring range of the measuring elements (52, 54, 56, 58).

6. The bottom bracket bearing (40) of claim 1, comprising a pulse generator (60) on a drive side of the torsion element (44) with an associated stationary incremental encoder (62) for determining a revolution rate or rotational speed of the bottom bracket bearing shaft (42), or
wherein a first or second measuring trigger (52, 54) with an assigned timer (56, 58) is used to determine a revolution rate or rotational speed of the bottom bracket bearing shaft (42), or
wherein the at least one first measuring trigger (52) is arranged on an outer surface of the bottom bracket bearing shaft (42) or on an outer surface of the drive-side end (46) of the torsion element (44), or
wherein the at least one second measuring trigger (54) is attached to a circumference of the outer surface of the driven-side end (48) of the torsion element (44), or
wherein the at least one first measuring trigger (52) and the at least one second measuring trigger (54) are axially aligned with each other.

7. The bottom bracket bearing (40) of claim 1, wherein a plurality of first measuring triggers (52) and a correspondingly equal number of second measuring triggers (54) are provided, wherein the first measuring triggers (52) are arranged distributed over a circumference of the bottom bracket bearing shaft (42) and protrude through recesses (53) provided for this purpose between the second measuring triggers (54) radially offset from the first measuring triggers (52) on a circumference of the driven-side end (48) of the torsion element (44) in such a way that an alternating arrangement of first and second measuring triggers (52, 54) is formed, wherein the recesses (53) form overload protection, or
wherein the first measuring triggers (52) or the second measuring triggers (54) are formed in one piece with the bottom bracket bearing shaft (42) or the torsion element (44), or
evaluation electronics formed on a circuit board (64), wherein the circuit board is arranged in or on a wall of a bottom bracket bearing housing (66), or
wherein the at least one first measuring trigger (52) and the at least one second measuring trigger (54) are configured so that radially outward-facing surfaces thereof are essentially at the same level.

8. A method for detecting the power on a bottom bracket bearing (40) of a muscle-powered vehicle (10), which contains a torsion element (44) connected to a drive side of a bottom bracket bearing shaft (42) of the bottom bracket bearing (40) so as to rotate therewith, said torsion element (44) comprising a torsion region (50) limited by a drive-side end (46) and an driven-side end (48), wherein a load-induced deformation of the torsion region (50) is determined by means of a measurement of a time offset between the driven-side end (48) and the drive-side end (46) arising under the action of a torque applied to the driven-side end (48) and a measurement of a rotational speed of the bottom bracket bearing shaft (42).

9. The method of claim 8, wherein a measuring range is defined by a twist limiter at the driven-side end (48) of the torsion element (44).

10. The method of claim 8, wherein the time offset is determined by means of a first measuring trigger (52) arranged on a drive side of the torsion element (44) and a second measuring trigger (54) arranged on the driven side of the torsion element (44), wherein the time measurement is triggered by a first measuring trigger (52) and is terminated by an assigned second measuring trigger (54), and wherein the first and second measuring triggers (52, 54) have an axially aligned position relative to each other defined in a rest state when torque is not applied to the driven-side end (48) of the torsion element (44), or wherein the first and second measuring triggers (52, 54) have a radially alternating position relative to each other defined in the rest state.

11. An apparatus (100) for controlling an electric drive (22) of a muscle-powered vehicle (10), comprising:
a power electronics module (110) which calculates a control variable for a motor current to be supplied to the electric drive (22) based on an input command variable reproducing a target acceleration,
an accelerometer (120) for measuring an actual acceleration of the vehicle (10), and
a comparison element (130) for comparing the actual acceleration with the target acceleration,
wherein the input command variable is calculated from a mechanically applied power detected on a bottom bracket bearing (40) of the vehicle (10) and the input command variable is fed into the comparison element (130) as the target acceleration and a value provided by the accelerometer (120) as the actual acceleration.

12. A vehicle (10), with an apparatus of claim 11 and a sensor for detecting a mechanically applied power and with a bottom bracket bearing (40) of claim 1.

13. A method for controlling an electric drive (22) of a muscle-powered vehicle (10), with the following steps:
determination of a mechanically applied power detected on a bottom bracket bearing (40) of the vehicle (10), according to the method of claim 8, and based on this, calculation of a target acceleration comprising:
determination of an actual acceleration of the vehicle (10),
comparison of the target acceleration and the actual acceleration in a comparison element for generation of an input command variable,
calculation, on the basis of the input command variable, of a control variable for a motor current to be supplied to the drive (22).
